(19) United States
(12) Patent Application Publication
(10) Pub. No.: US 2018/0320976 A1
(43) Pub. Date: Nov. 8, 2018

(54) INTEGRAL HEAT EXCHANGER

(71) Applicant: Hanon Systems, Daejeon (KR)

(72) Inventors: A-Ra Jo, Daejeon (KR); Tae-Soo Chun, Daejeon (KR); Taek-Keun Kim, Daejeon (KR); Yang-Woo Lee, Daejeon (KR)

(21) Appl. No.: 16/028,646

(22) Filed: Jul. 6, 2018

Related U.S. Application Data
(62) Division of application No. 14/907,011, filed on Jan. 22, 2016.

(30) Foreign Application Priority Data
Jul. 16, 2014 (KR) 10-2014-0089938
Jan. 6, 2015 (KR) 10-2015-0001228
Jan. 6, 2015 (KR) 10-2015-0001229
Jan. 6, 2015 (KR) 10-2015-0001422

(51) Int. Cl. F28D 1/04; F28F 9/02; F28F 1/36

(52) U.S. Cl. CPC F28D 1/0443; F28F 9/0265; F28F 9/0212; F28F 1/36; F28D 2021/0082; Y02T 10/146; F28F 9/0234

(57) ABSTRACT

The present invention relates to an integral heat exchanger including: a first heat exchange portion for performing the heat exchange of a first heat exchange medium with external air; a second heat exchange portion separated from the first heat exchange portion and performing the heat exchange of a second heat exchange medium with the first heat exchange medium; and a third heat exchange portion for introducing the second heat exchange medium passing through the second heat exchange portion and to perform the heat exchange of the introduced second heat exchange medium with external air, wherein the first to third heat exchange portions are formed in one body integrally to each other.

### CROSS-REFERENCE TO RELATED APPLICATIONS

This patent application is a divisional patent application of U.S. patent application Ser. No. 14/907,011, which is a United States national phase patent application based on PCT patent application number PCT/KR2015/004199 filed Apr. 28, 2015, which claims the benefit of Korean Patent Application Nos. 10-2014-0089938 dated Jul. 16, 2014, 10-2015-0001422 dated Jan. 6, 2015, 10-2015-0001228 dated Jan. 6, 2015, and 10-2015-0001229 dated Jan. 6, 2015. The disclosures of the above patent applications are hereby incorporated herein by reference in their entirety.

### FIELD OF THE INVENTION

The present invention relates to an integral heat exchanger, and more particularly, to an integral heat exchanger that conducts the heat exchange of a first heat exchange medium in an air-cooled manner and conducts the heat exchange of a second heat exchange medium in a water-cooled and air-cooled manner.

### BACKGROUND OF THE RELATED ART

A radiator and an intercooler are components of a heat exchanger, and first, the radiator is adapted to prevent an engine or electronic parts from being raised over a given temperature.

Generally, an internal combustion engine always generates a large amount of heat during high temperature and high pressure gas is burnt, and if the heat is not cooled appropriately, various parts like cylinders and pistons may be damaged due to the overheating of the engine. Accordingly, a jacket in which cooling water is accommodated is located around the cylinder, and as the cooling water in the jacket is circulated, it absorbs the heat generated from the engine, thus allowing the engine to be cooled. That is, the radiator is the heat exchanger configured wherein high temperature cooling water absorbing the heat generated by the combustion through the circulation along the interior of the engine is circulated by means of a water pump and emits the heat to the outside, thus preventing the overheating of the engine and maintaining an optimal operating state. Also, a variety of electronic parts have been recently mounted at the interior of a vehicle, and accordingly, a radiator for circulating the cooling water cooling the various electronic parts and emitting heat to the outside is further provided.

On the other hand, the intercooler is a device for cooling the air compressed to high temperature and high pressure by means of a charger so as to increase the output of the engine.

Generally, the charger, which supplies the compressed air to the interior of the cylinder of the engine, is used in a vehicle using a diesel engine so as to improve the output of the engine. However, the rapidly compressed air through the charger is very raised in temperature so that it has an expanded volume and a low degree of oxygen concentration, thus causing the charging efficiency in the cylinder to be decreased. At this time, the intercooler serves to cool the high temperature air compressed by the charger, and accordingly, if the vehicle has the intercooler, the absorption efficiency of the engine cylinder is enhanced, the combustion efficiency is improved, and the discharge of exhaust gas harmful to environments like carbon dioxide and smoke is greatly decreased.

The intercooler is classified into water-cooled and air-cooled intercoolers according to cooling ways. An example of an air-cooled intercooler 10′ widely used is shown in FIG. 1, and the intercooler 10′ includes: a first header tank 20′ and a second header tank 30′ spaced apart from each other by a given distance in parallel to each other; an inlet pipe 40′ and an outlet pipe 50′ located on the second header tank 20′ and the first header tank 30′ to introduce and discharge air thereinto and therefrom; a plurality of tubes 60′ whose both ends fixed to the first header tank 20′ and the second header tank 30′ to form air passages; and fins 70′ disposed between the adjacent tubes 60′. At this time, the intercooler 10′ is configured wherein external air is forcedly blown at the state of being compressed through the rotation of a turbine by the exhaust pressure of an engine and then introduced into the first header tank 20′ through the inlet pipe 40′. The air introduced into the first header tank 20′ is moved along the air passages of the tubes 60′ to the second header tank 30′, cooled through the heat exchange with the air passing through the fins 70′, and then discharged through the outlet pipe 50′ of the second header tank 30′.

On the other hand, the water-cooled intercooler has the similar operating principle to the air-cooled intercooler 10′, and when internal charge air is cooled, the water-cooled intercooler uses cooling water or water of the vehicle, instead of the external air, so that the cooling efficiency is excellent, but the intercooler structure is complicated, thus making it difficult in installation and maintenance.

FIG. 2 is a schematic diagram showing a conventional cooling system with a water-cooled intercooler.

As shown in FIG. 2, the conventional cooling system further includes an auxiliary radiator 20 for cooling the cooling water heat-exchanged with the high temperature air compressed by the charger again. Furthermore, the conventional cooling system includes: a cooling water passage 40 along which the cooling water flowing in the water-cooled intercooler 10 and the auxiliary radiator 20 is circulated; and a water pump 30. Like this, the cooling system having the water-cooled intercooler 10 includes a large number of parts, so that the structure of the system becomes complicated, and further, there is a limit in the temperature cooled only with the heat exchange with the cooling water, so that the heat exchange efficiency of the system may be decreased.

Accordingly, there is a need to develop a charge air cooling system capable of providing simple heat exchange with the high temperature air compressed by the charger, easy assembling, and free space utilization.

### SUMMARY OF THE INVENTION

Accordingly, the present invention has been made in view of the above-mentioned problems occurring in the prior art, and it is an object of the present invention to provide an integral heat exchanger that includes a first heat exchange portion for performing the heat exchange of a first heat exchange medium with external air, a second heat exchange portion formed in a first header tank of the first heat exchange portion or a second header tank to perform the heat exchange of a second heat exchange medium with the first heat exchange medium, and a third heat exchange portion for introducing the second heat exchange medium passing through the second heat exchange portion thereinto and performing the heat exchange of the second heat exchange medium with external air, wherein the first to third heat exchange portions are formed in one body integrally to each other.

To accomplish the above-mentioned object, according to a first aspect of the present invention, there is provided an integral heat exchanger including: a first heat exchange portion for introducing a first heat exchange medium and performing the heat exchange of the first heat exchange medium with external air; a second heat exchange portion for introducing a second heat exchange medium and performing the heat exchange of the second heat exchange medium with the first heat exchange medium passing through the first heat exchange portion; and a third heat exchange portion for introducing the second heat exchange medium passing through the second heat exchange portion and performing the heat exchange of the second heat exchange medium with external air, wherein the first heat exchange medium is cooled by the external air, and the second heat exchange medium is cooled by the first heat exchange medium and the external air, thus allowing the first to third heat exchange portions to be formed in one body integrally to each other.

According to the present invention, preferably, the first heat exchange medium is cooling water for electronic parts, and the second heat exchange medium is charge air, so that the integral heat exchanger integrates a radiator for electronic parts, a water-cooled intercooler and an air-cooled intercooler, and cools the charge air through the second heat exchange portion serving as the water-cooled intercooler, thus maintaining a temperature higher than a dew point upon initial starting of a vehicle to prevent the production of condensed water.

To accomplish the above-mentioned object, according to a second aspect of the present invention, there is provided an integral heat exchanger including: a first header tank and a second header tank spaced apart from each other by a given distance in parallel to each other; a first partition member for partitioning the internal space of the first header tank into a first space portion and a second space portion in a longitudinal direction of the first header tank; a second partition member located at the same position as the first partition member and partitioning the internal space of the second header tank into a third space portion and a fourth space portion in a longitudinal direction of the second header tank; first tubes whose both ends fixed to the first space portion of the first header tank and the third space portion of the second header tank to form first heat exchange medium passages; a heat exchange member inserted into the third space portion of the second header tank in the longitudinal direction of the second header tank to form the space in which the second heat exchange medium is moved to the fourth space portion; second tubes whose both ends fixed to the second space portion of the first header tank and the fourth space portion of the second header tank to form second heat exchange medium passages; and fins disposed between the first tubes and between the second tubes.

According to the present invention, preferably, the integral heat exchanger further includes: a first inlet portion formed on one of the first space portion of the first header tank and the third space portion of the second header tank in such a manner as to introduce the first heat exchange medium thereinto; a first outlet portion formed on one of the first space portion of the first header tank and the third space portion of the second header tank in such a manner as to discharge the first heat exchange medium therefrom; a second inlet portion formed on the third space portion of the second header tank in such a manner as to introduce the second heat exchange medium thereinto and supply the second heat exchange medium to the heat exchange member; and a second outlet portion formed on the second space portion of the first header tank in such a manner as to discharge the second heat exchange medium therefrom.

According to the present invention, preferably, the heat exchange member has a shape of a longitudinally elongated pipe, and the heat exchange member includes one pipe or two or more pipes.

According to the present invention, preferably, if the heat exchange member has two or more pipes, the heat exchange member includes first pipes and second pipes having different sectional shapes from each other so as to evenly distribute the second heat exchange medium.

According to the present invention, preferably, the internal sectional area of each second pipe is smaller than that of each first pipe, so that the second pipes are located on a portion in which the second heat exchange medium is collectively introduced, thus preventing the heat exchange efficiency from being decreased due to the collection of the second heat exchange medium to the specific pipes of the heat exchange member.

According to the present invention, preferably, each second pipe has first concave portions concaved inwardly in the longitudinal direction thereof.

According to the present invention, preferably, the heat exchange member has a spiral protrusion formed along the outer peripheral surface thereof, thus increasing the contact area with the first heat exchange medium, guiding the movement of the first heat exchange medium, and enhancing the performance of the heat exchange between the first heat exchange medium and the second heat exchange medium.

According to the present invention, preferably, the second inlet portion includes a pipe-shaped connection portion formed in the longitudinal direction of the second header tank, an expanded portion extended from the connection portion in such a manner as to be increased in an internal diameter, and a fixed portion extended from the expanded portion in such a manner as to be fixed to one side of the second header tank, so that the charge air is gently supplied to the heat exchange member.

According to the present invention, preferably, the integral heat exchanger further includes a distribution member located inside the second inlet portion so as to evenly distribute the second heat exchange medium to the heat exchange member.

According to the present invention, preferably, the distribution member has a shape of a plate having communication holes hollowed on a given area thereof, and the hollowed areas of the communication holes in which the second heat exchange medium is collected are smaller than those of other communication holes.

According to the present invention, preferably, the distribution member includes: a first communication area located at the center thereof; and a second communication area formed around the first communication area and having the hollowed areas of the communication holes larger than those of the communication holes on the first communication area.

According to the present invention, preferably, the second communication area includes third communication areas and fourth communication areas located adjacent to the corners and having the hollowed areas of the communication holes larger than those of the communication holes on the third communication areas.

According to the present invention, preferably, the distribution member has the communication holes hollowed thereon correspondingly to the respective pipes constituting the heat exchange member.

According to the present invention, preferably, each communication hole on the area in which the second heat exchange medium is collected has second concave portions concaved inwardly therefrom.

According to the present invention, preferably, the distribution member includes an inclined portion increased in width toward the interior of the second header tank from the second inlet portion and support portions for supporting the inclined portion thereagainst.

According to the present invention, preferably, the heat exchange member has a shape of a plate partitioning the internal space of the second header tank into both sides in the longitudinal direction of the second header tank.

According to the present invention, preferably, the integral heat exchanger further includes a third partition member for partitioning one side of the second header tank and the second inlet portion, thus forming the space in which the first heat exchange medium is moved.

According to the present invention, preferably, the first tubes and the second tubes have different hydraulic diameters from each other.

According to the present invention, preferably, the second space portion and the fourth space portion are formed at the lower side of the integral heat exchange in a direction of a height of a vehicle, so that an amount of vehicle wind introduced is relatively large to enhance the heat exchange efficiency of the second heat exchange medium.

According to the present invention, preferably, the first heat exchange medium introduced through the first inlet portion is moved to the first heat exchange portion in which the heat exchange of the first heat exchange medium with the external air is conducted, while passing through the first space portion of the first header tank, the first tubes, and the third space portion of the second header tank, and discharged through the first outlet portion, and the second heat exchange medium introduced through the second inlet portion is moved to the second heat exchange portion in which the heat exchange of the second heat exchange medium with the first heat exchange medium is conducted, while passing through the heat exchange member, moved to the third heat exchange portion in which the heat exchange of the second heat exchange medium with the external air is conducted, while passing through the fourth space portion of the second header tank, the second tubes, and the second space portion of the first header tank, and discharged through the second outlet portion.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a conventional intercooler;

FIG. 2 is a schematic diagram showing a conventional cooling system with a water-cooled intercooler;

FIG. 3 is a schematic view showing an integral heat exchanger according to a first embodiment of the present invention;

FIGS. 4 and 5 are perspective and exploded perspective views showing the integral heat exchanger according to the first embodiment of the present invention;

FIGS. 6 and 7 are schematic views showing an integral heat exchanger according to second and third embodiments of the present invention;

FIGS. 8 and 9 are perspective and schematic views showing an integral heat exchanger according to a fourth embodiment of the present invention;

FIG. 10 is a schematic view showing an integral heat exchanger according to a fifth embodiment of the present invention;

FIGS. 11 to 15 are perspective, exploded perspective, sectional, and front views showing an integral heat exchanger according to a sixth embodiment of the present invention and a sectional view showing a second header tank in the integral heat exchanger according to the present invention;

FIGS. 16 and 17 are an exploded perspective view showing an integral heat exchanger according to a seventh embodiment of the present invention and a sectional view showing a second header tank in the integral heat exchanger according to the present invention;

FIGS. 18a to 18d are sectional views showing other second header tanks;

FIGS. 19 to 22 are exploded perspective and sectional views showing an integral heat exchanger according to an eighth embodiment of the present invention and perspective and plan views showing a distribution member in the integral heat exchanger according to the present invention;

FIGS. 23a to 23c are plan views showing other distribution members;

FIGS. 24 and 25 are an exploded perspective view showing an integral heat exchanger according to a ninth embodiment of the present invention and a plan view showing a distribution member in the integral heat exchanger according to the present invention;

FIGS. 26a to 26c are plan views showing other distribution members;

FIGS. 27 to 29 are an exploded perspective and partial sectional views showing an integral heat exchanger according to a tenth embodiment of the present invention and a perspective view showing a distribution member in the integral heat exchanger according to the present invention; and

FIG. 30 is a perspective view showing another heat exchange member in the integral heat exchanger according to the present invention.

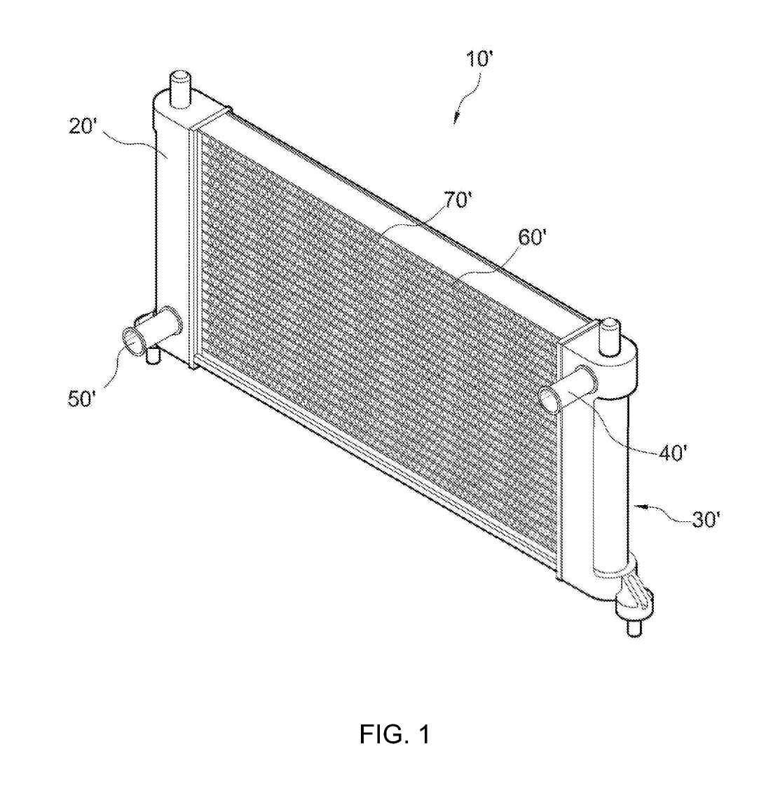

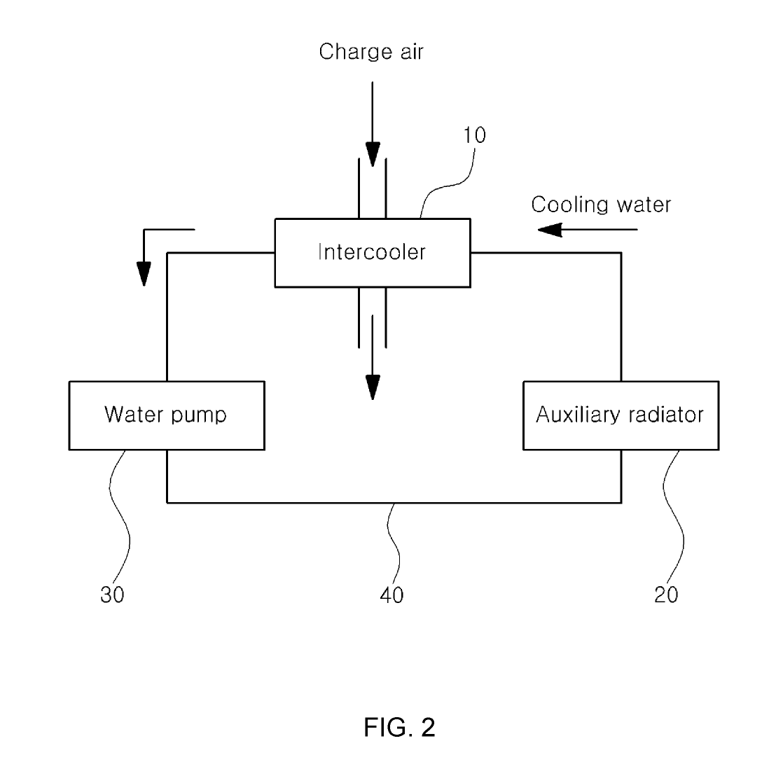

### EXPLANATION OF REFERENCE NUMERALS

1000: integrated heat exchanger
A1: first heat exchange portion
A2: second heat exchange portion
A3: third heat exchange portion
100: first header tank
101: first space portion
102: second space portion
110: first partition member
200: second header tank
201: third space portion
202: fourth space portion
210: second partition member
211: insertion hole
220: third partition member
221: insertion hole
300: first tube
400: second tube
500: heat exchange member
501: spiral protrusion
510: first pipe
520: second pipe
521: first concave portion
600: fin
710: first inlet portion
720: first outlet portion
730: second inlet portion
731: connection portion
732: expanded portion
733: fixed portion
740: second outlet portion
800: distribution member
801: communication hole
801a: second concave portion
802: inclined portion
803: support portion
A810: first communication area
A820: second communication area
A821: third communication area
A822: fourth communication area

### DETAILED DESCRIPTION OF THE PREFERRED EMBODIMENTS

Hereinafter, an explanation on an integral heat exchanger according to the present invention will be in detail given with reference to the attached drawing.

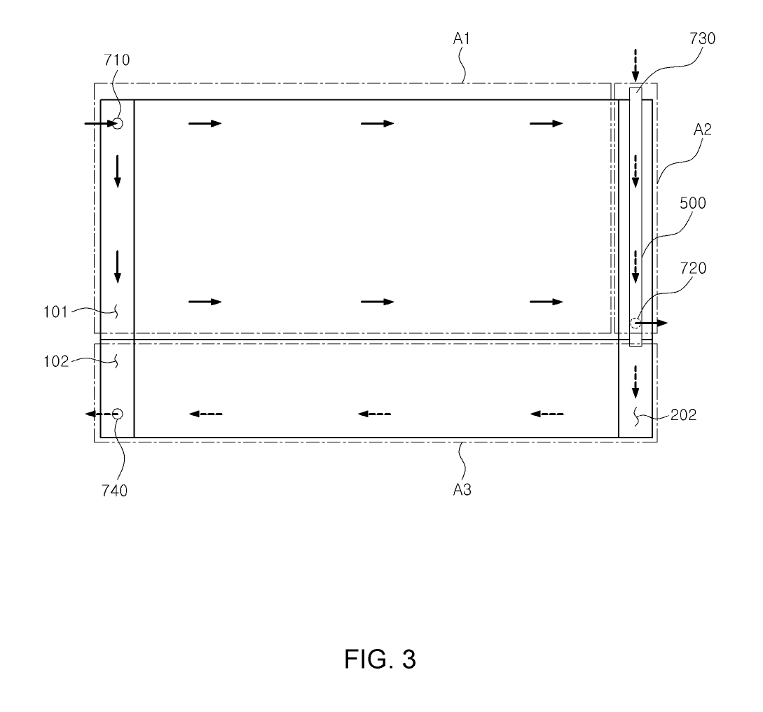

FIG. 3 is a schematic view showing an integral heat exchanger 1000 according to a first embodiment of the present invention. The integral heat exchanger 1000 according to the first embodiment of the present invention includes: a first heat exchange portion A1 for performing the heat exchange of a first heat exchange medium with external air; a second heat exchange portion A2 separated from the first heat exchange portion A1 and performing the heat exchange of a second heat exchange medium with the first heat exchange medium; and a third heat exchange portion A3 for introducing the second heat exchange medium passing through the second heat exchange portion A2 thereinto and performing the heat exchange of the second heat exchange medium with external air, wherein the first to third heat exchange portions A1 to A3 are formed in one body integrally to each other. That is, the integral heat exchanger 1000 according to the present invention largely includes the first heat exchange portion A1, the second heat exchange portion A2, and the third heat exchange portion A3.

The first heat exchange portion A1 introduces the first heat exchange medium, moves the first heat exchange medium, and performs the heat exchange of the first heat exchange medium with the external air like vehicle wind, and the second heat exchange portion A2 introduces the second heat exchange medium and performs the heat exchange of the second heat exchange medium with the first heat exchange medium passing through the first heat exchange portion A1. Further, the third heat exchange portion A3 introduces the second heat exchange medium passing through the second heat exchange portion A2 and performs the heat exchange of the introduced second heat exchange medium with external air.

At this time, the first heat exchange medium is cooling water for electronic parts, and the second heat exchange medium is charge air. In this case, the first heat exchange portion A1 serves as the existing radiator for cooling the electronic parts, the second heat exchange portion A2 water-cooled intercooler, and the third heat exchange portion A3 air-cooled intercooler. That is, the integral heat exchanger 1000 according to the present invention is configured wherein a plurality of heat exchangers is formed in one body integrally to each other, thus making the heat exchanger miniaturized and providing easy manufacturing and mounting.

Next, an explanation on the configuration of the integral heat exchanger 1000 according to the present invention will be in more detail given.

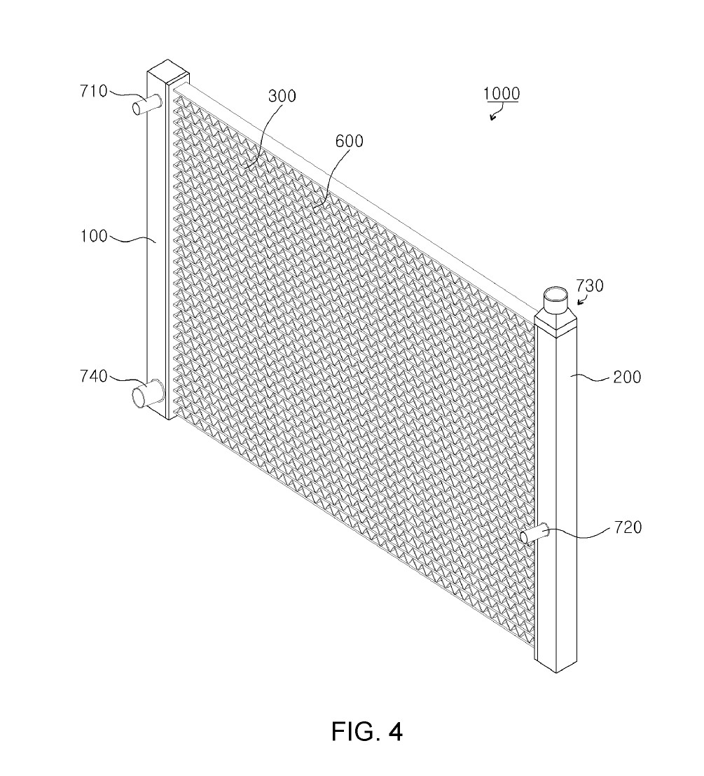

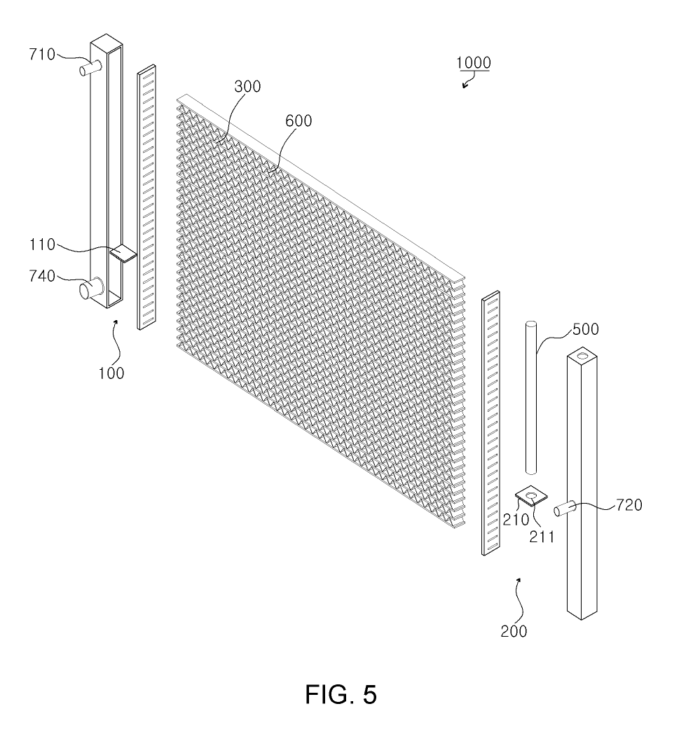

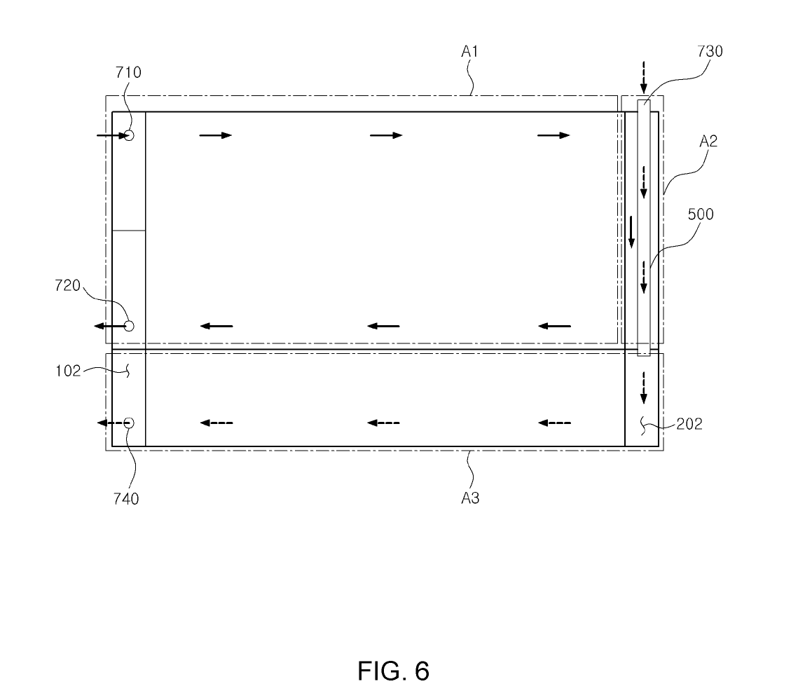

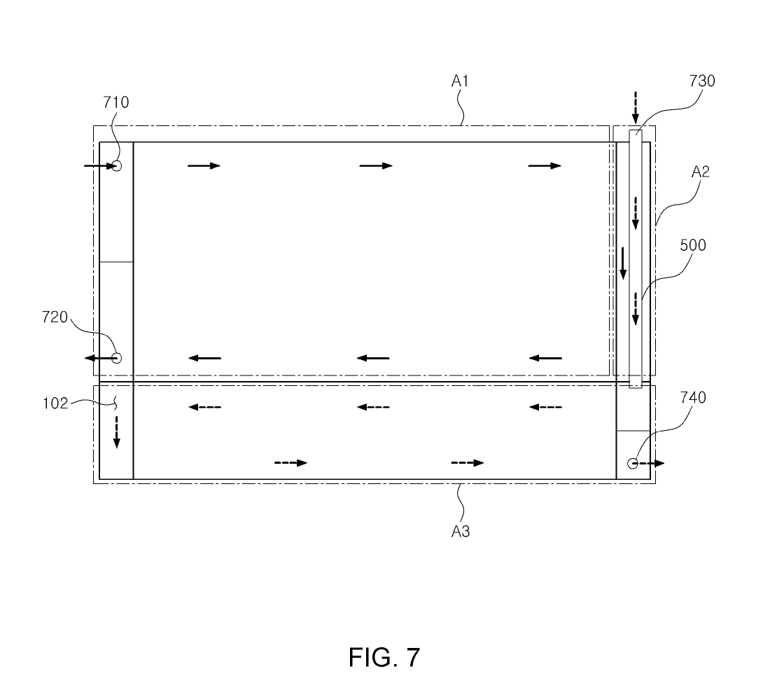

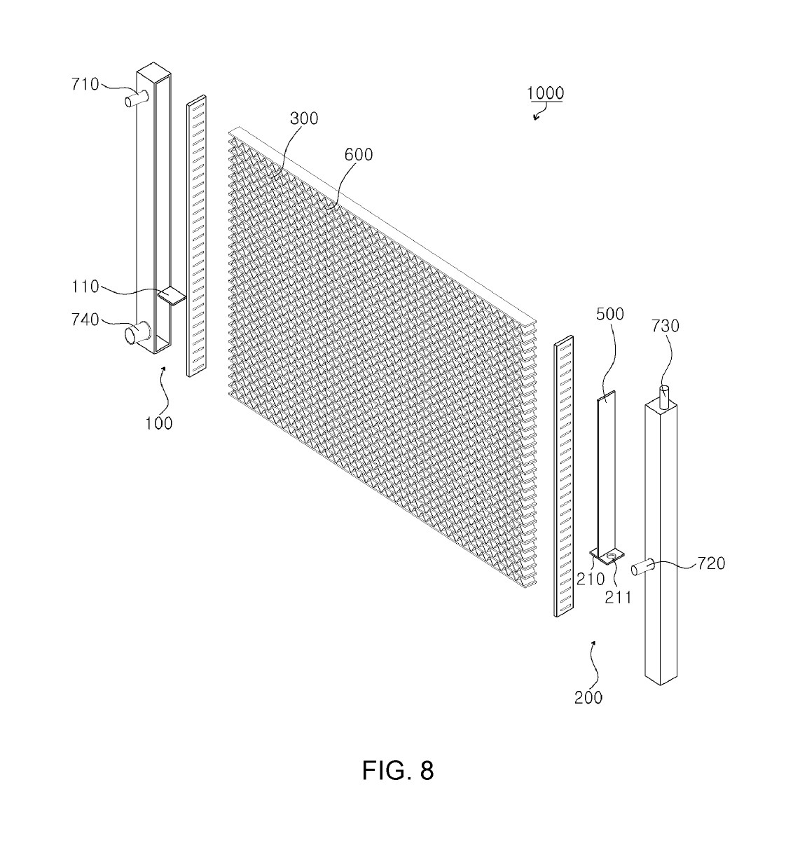

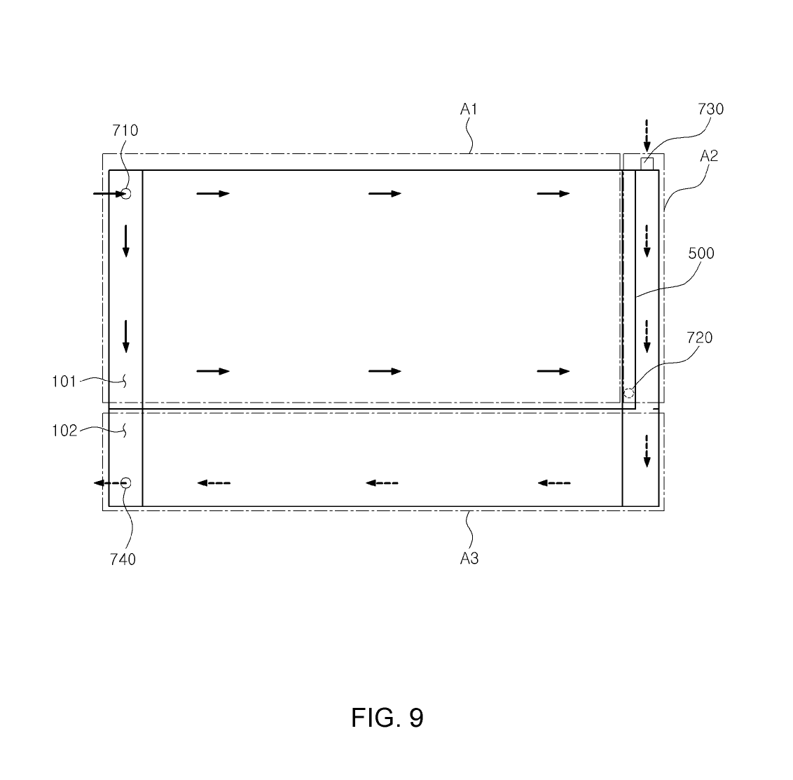

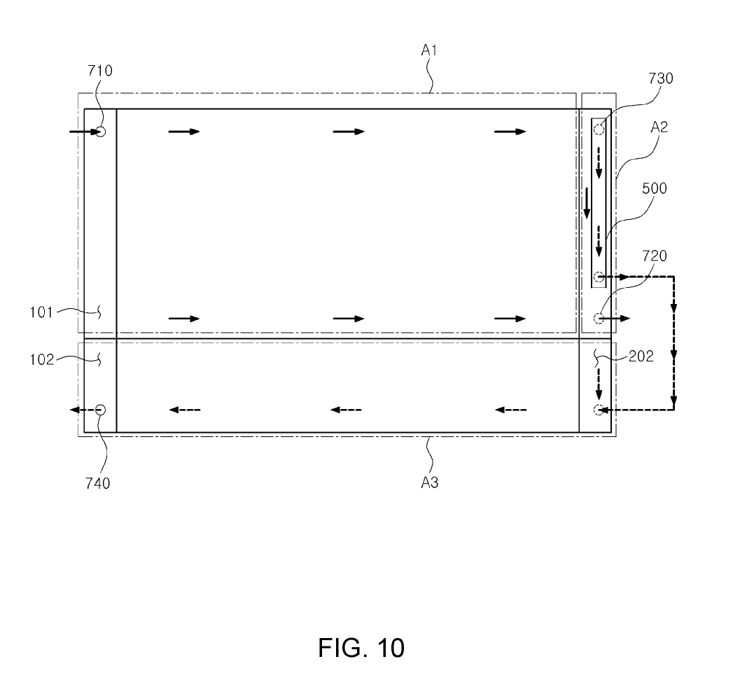

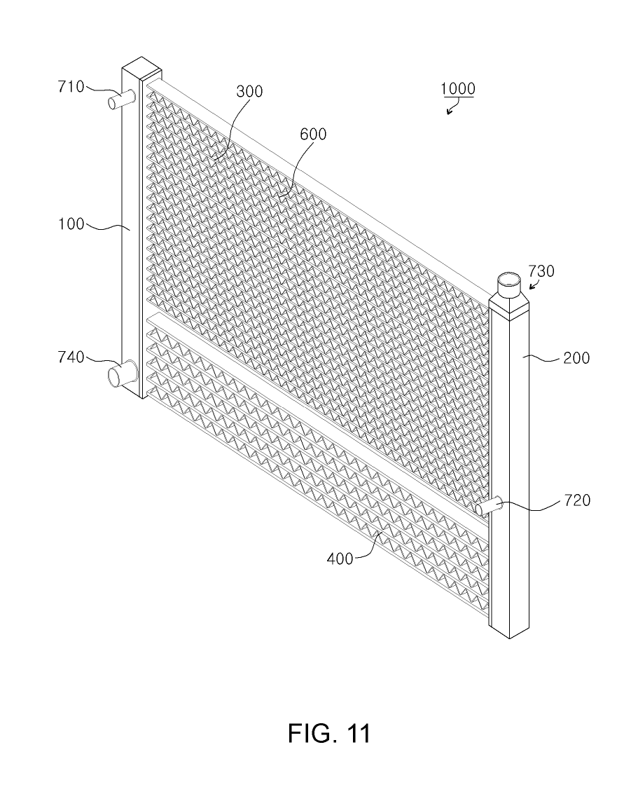

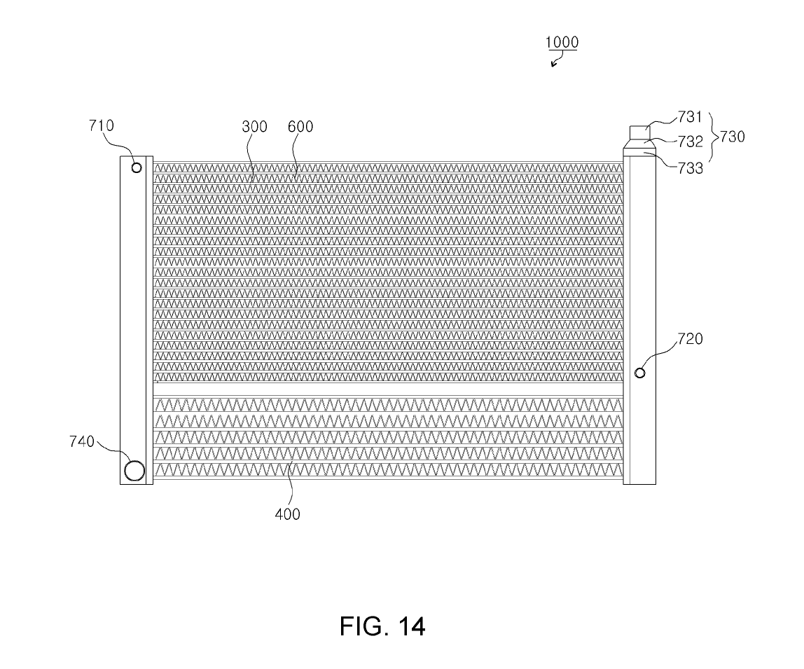

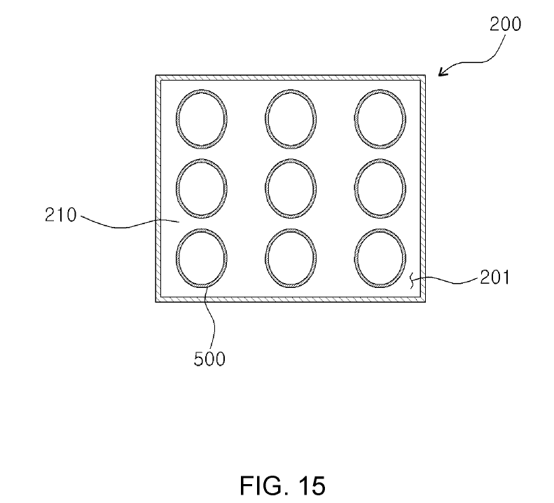

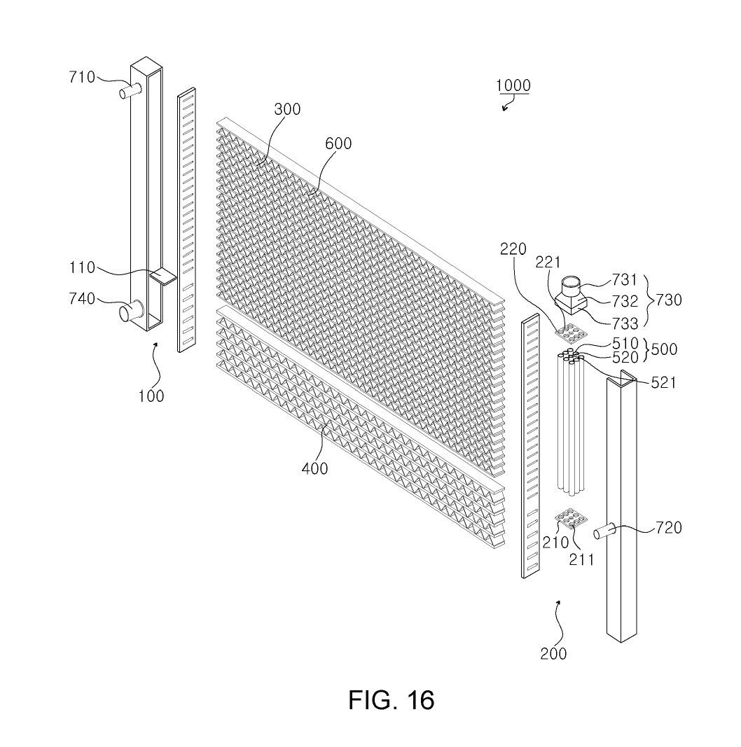

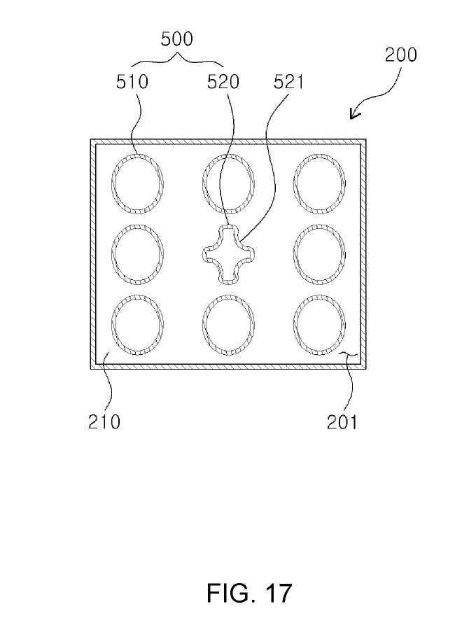

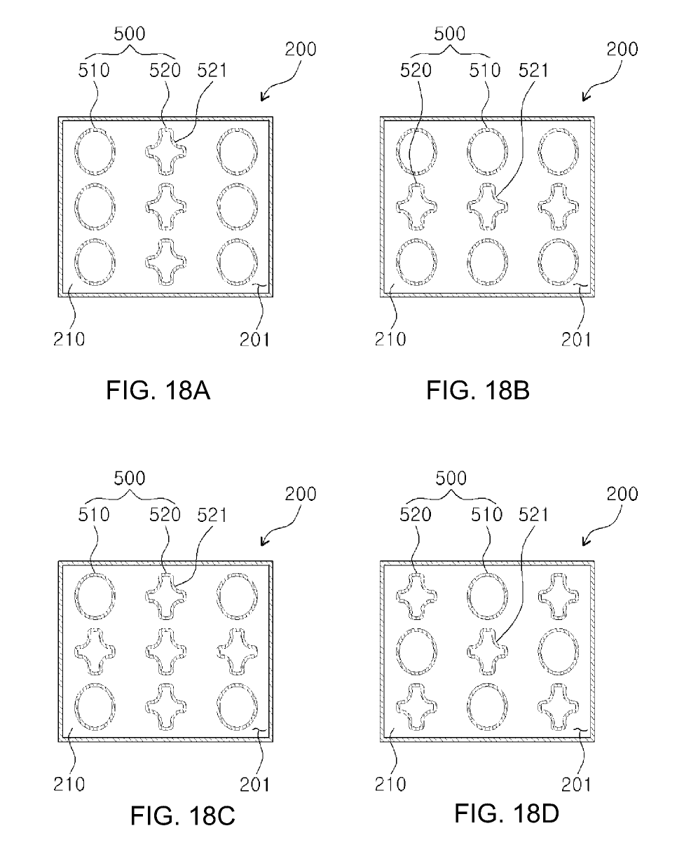

FIGS. 4 and 5 are perspective and exploded perspective views showing the integral heat exchanger according to the first embodiment of the present invention, FIGS. 6 and 7 are schematic views showing an integral heat exchanger according to second and third embodiments of the present invention, FIGS. 8 and 9 are perspective and schematic views showing an integral heat exchanger according to a fourth embodiment of the present invention, FIG. 10 is a schematic view showing an integral heat exchanger according to a fifth embodiment of the present invention, FIGS. 11 to 15 are perspective, exploded perspective, sectional, and front views showing an integral heat exchanger according to a sixth embodiment of the present invention and a sectional view showing a second header tank in the integral heat exchanger according to the present invention, FIGS. 16 and 17 are an exploded perspective view showing an integral heat exchanger according to a seventh embodiment of the present invention and a sectional view showing a second header tank in the integral heat exchanger according to the present invention, and FIGS. 18a to 18d are sectional views showing other second header tanks.

The integral heat exchanger 1000 according to the present invention includes a first header tank 100, a second header tank 200, a first partition member 110, a second partition member 210, first tubes 300, a heat exchange member 500, second tubes 400, and fins 600.

The first header tank 100 and the second header tank 200 are spaced apart from each other by a given distance in parallel to each other in such a manner to form respective internal spaces in which the first heat exchange medium and the second heat exchange medium flow.

In more detail, the first header tank 100 has the first partition member 110 disposed at the inside thereof in such a manner as to partition the internal space into a first space portion 101 and a second space portion 102 in a longitudinal direction thereof. The first space portion 101 is one space partitioned by the first partition member 110 of the first header tank 100, along which the first heat exchange medium flows. Further, the second space portion 102 is the other space partitioned by the first partition member 110 of the first header tank 100, along which the second heat exchange medium flows.

Further, the second header tank 200 has the second partition member 210 disposed at the inside thereof in such a manner as to partition the internal space into a third space portion 201 and a fourth space portion 202 in a longitudinal direction thereof. The second partition member 210 is located at the same position as the first partition member 110 to partition the internal space of the second header tank 200 in the longitudinal direction of the second header tank 200. The third space portion 201 is formed at the corresponding position to the first space portion 101 of the first header tank 100 in the longitudinal direction of the second header tank 200, and the fourth space portion 202 is formed at the corresponding position to the second space portion 102. The first heat exchange medium flows along the third space portion 201, and at this time, the heat exchange member 500, along which the second heat exchange medium flows, is located inside the third space portion 201, so that the heat exchange between the first heat exchange medium and the second heat exchange medium is performed. Further, the second heat exchange medium flows along the fourth space portion 202.

As shown in FIGS. 4 and 5, the first header tank 100 and the second header tank 200 are spaced apart from each other in left and right directions, but of course, they may be spaced apart from each other in up and down directions.

The first tubes 300 have both ends fixed to the first space portion 101 of the first header tank 100 and the third space portion 201 of the second header tank 200, thus forming first heat exchange medium passages.

The heat exchange member 500 is inserted into the third space portion 201 of the second header tank 200 in such a manner as to be passed through the second partition member 210 and thus supplies the second head exchange medium to the fourth space portion 202. That is, the heat exchange member 500 is disposed at the interior of the third space portion 201 of the second header tank 200, moves the second heat exchange medium therealong, performs the heat exchange of the second heat exchange medium with the outside first heat exchange medium, primarily cools the second heat exchange medium, and supplies the second heat exchange medium to the fourth space portion 202 of the second header tank 200. The heat exchange member 500 cools the second heat exchange medium in a water-cooled manner.

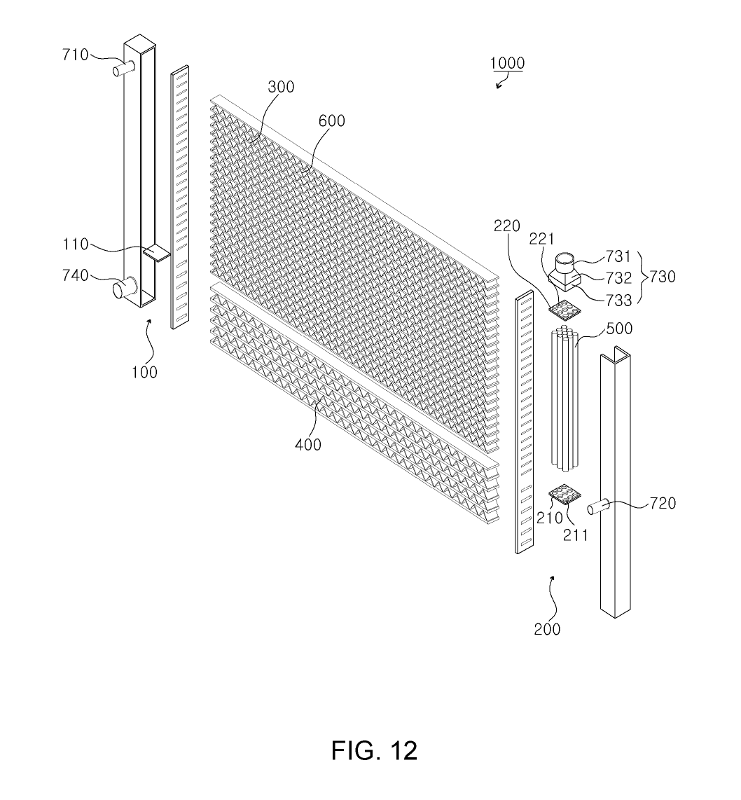

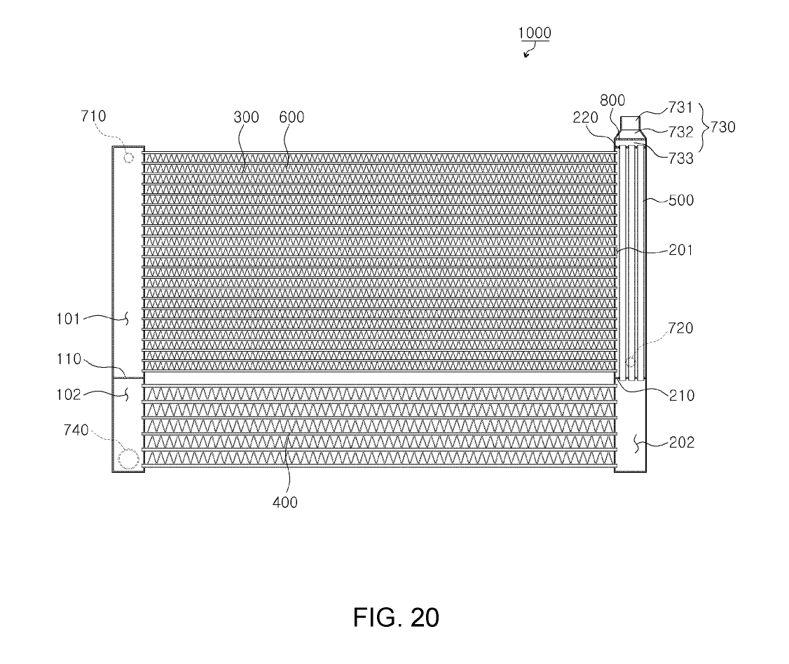

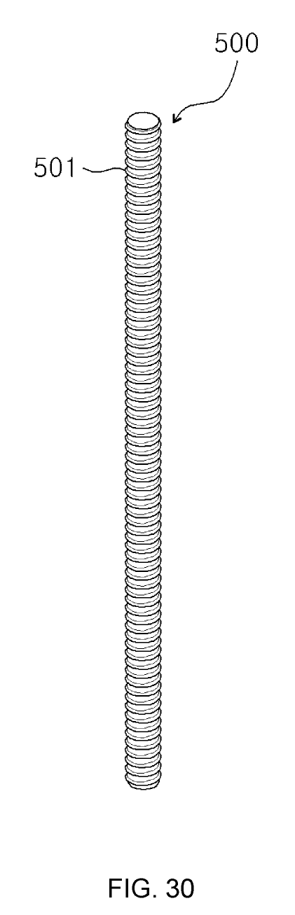

The heat exchange member 500 may have a variety of shapes, and as shown in FIGS. 5 to 7, the heat exchange member 500 has a shape of a cylinder having a length equal to or longer than the third space portion 201 of the second header tank 200. As shown in FIGS. 8 and 9, the heat exchange member 500 has a shape of a plate, and as shown in FIG. 10, it has a shape of a cylinder completely inserted into the third space portion 201 of the second header tank 200. Further, as shown in FIGS. 12 to 20, 24, 27 and 28, the heat exchange member 500 includes a plurality of pipes, and as shown in FIG. 30, the heat exchange member 500 has a spiral protrusion 501 formed along the outer peripheral surface thereof. According to the present invention, the cylinder may include circular and oval sections. Through the formation of the spiral protrusion 501 as shown in FIG. 30, the heat exchange area to the first heat exchange medium is more increased to provide high heat exchange efficiencies.

As shown in FIGS. 16 to 18d, if the heat exchange member 500 includes two or more pipes, it has first pipes 510 and second pipes 520 having different sectional shapes from each other. At this time, the internal sectional areas of the second pipes 520 are smaller than those of the first pipes 510, so that the second pipes 520 are located at a portion where an amount of the second heat exchange medium supplied is large and the first pipes 510 are located at a portion where an amount of the second heat exchange medium supplied is small, thus allowing the second heat exchange medium to be evenly supplied to the plurality of pipes. At this time, each second pipe 520 has first concave portions 521 concaved inwardly in the longitudinal direction thereof, and as shown in FIG. 17, the four first concave portions 521 are formed along the outer peripheral surface of the second pipe 520. Accordingly, the integral heat exchanger 1000 according to the present invention is capable of evenly distributing the second heat exchange medium to the heat exchange member 500 having the plurality of first and second pipes 510 and 520, thus enhancing the heat exchange efficiencies.

The integral heat exchanger 1000 according to the present invention has various arrangements of the heat exchange member 500 having the plurality of first and second pipes 510 and 520, and as shown in FIG. 17, the heat exchange member 500 (having the plurality of first and second pipes 510 and 520) has an arrangement of 3×3, and in this arrangement, the second pipe 520 is located at the center thereof, while the eight first pipes 510 are located to surround the second pipe 520. Further, FIGS. 18a to 18d show the integral heat exchanger 1000 having a variety of arrangements of 3×3, wherein FIG. 18a shows an example wherein the second pipes 520 are located at a second column and the first pipes 510 at first and third columns, and FIG. 18b shows an example wherein the second pipes 520 are located at a second row and the first pipes 510 at first and third rows. Further, FIG. 18c shows an example wherein the five second pipes 520 are located at a second column and a second row and the first pipes 510 at corner portions, and FIG. 18d shows an example wherein the second pipes 520 are located at the center and corner portions and the first pipes 510 at the entire portion except the center and corner portions.

The integral heat exchanger 1000 according to the present invention is configured to variously change the number of first concave portions 521 of the heat exchange member 500, the number of pipes constituting the heat exchange member 500, and the arrangements of the first pipes 510 and the second pipes 520.

In case where the heat exchange member 500 is passed through the second partition member 210 to supply the second heat exchange medium to the fourth space portion 202 of the second header tank 200, on the other hand, the second partition member 210 has insertion holes 211 formed thereon in such a manner as to correspond to the first and second pipes of the heat exchange member 500. If the heat exchange member 500 has the first pipes 510 and the second pipes 520, further, the insertion holes 211 have the corresponding shapes to the first pipes 510 and the second pipes 520.

Further, as shown in FIG. 10, if the heat exchange member 500 has the shape of the cylinder having a given length in such a manner as to be disposed at the interior of the third space portion 201 of the second header tank 200, there is a member (not shown) connecting the second heat exchange portion A2 and the third heat exchange portion A3 with each other.

The second tubes 400 have both ends fixed to the second space portion 102 of the first header tank 100 and the fourth space portion 202 of the second header tank 200, thus forming second heat exchange medium passages.

According to the integral heat exchanger 1000 of the present invention, at this time, the first heat exchange medium flows in the first tubes 300, and the second heat exchange medium flows in the second tubes 400. As shown in FIGS. 4 and 5, the hydraulic diameters of the first tubes 300 and the second tubes 400 are the same as each other in view of their manufacturing, and as shown in FIGS. 11 and 12, they are different from each other in view of the flowing of the media having different physical properties.

The fins 600 are disposed between the first tubes 300 and between the second tubes 400.

The integral heat exchanger 1000 according to the present invention further includes a first inlet portion 710 for introducing the first heat exchange medium, a first outlet portion 720 for discharging the first heat exchange medium, a second inlet portion 730 for introducing the second heat exchange medium, and a second outlet portion 740 for discharging the second heat exchange medium.

In the embodiment shown in FIGS. 8 and 9, the first inlet portion 710 and the first outlet portion 720 are formed on the first space portion 101 of the first header tank 100 and the third space portion 201 of the second header tank 200 in such a manner as to introduce and discharge the first heat exchange medium thereinto and therefrom. As shown in FIG. 9, the first inlet portion 710 communicates with the first space portion 101 of the first header tank 100, and the first outlet portion 720 with the third space portion 201 of the second header tank 200, so that the first heat exchange medium introduced through the first inlet portion 710 is moved to the third space portion 201 via the first space portion 101 of the first header tank 100 and the first tubes 300, heat-exchanged with the external air, and discharged through the first outlet portion 720. The integral heat exchanger 1000 according to the present invention may have the first inlet portion 710 and the first outlet portion 720 formed at various positions.

Referring to the embodiment shown in FIGS. 11-15, the second inlet portion 730 introduces the second heat exchange medium and is formed on the third space portion 201 of the second header tank 200 to supply the second heat exchange medium to the heat exchange member 500. At this time, the second inlet portion 730 includes a pipe-shaped connection portion 731 formed in the longitudinal direction of the second header tank 200, an expanded portion 732 extended from the connection portion 731 in such a manner as to be increased in an internal diameter, and a fixed portion 733 extended from the expanded portion 732 in such a manner as to be fixed to one side of the second header tank 200. Accordingly, the integral heat exchanger 1000 according to the present invention is easily connected to a pipe for supplying the second heat exchange medium thereto, thus minimizing the loss in the pressure of the second heat exchange medium.

The first inlet portion 710, the first outlet portion 720, the second inlet portion 730 and the second outlet portion 740 are formed at various positions. First, as shown in FIG. 3, the first inlet portion 710 is formed at the upper side of the first space portion 101 of the first header tank 100, and the first outlet portion 720 at the lower side of the third space portion 201 of the second header tank 200, so that the first heat exchange medium introduced into the first space portion 101 of the first header tank 100 through the first inlet portion 710 is moved to the third space portion 201 of the second header tank 200 along the first tubes 300 and discharged through the first outlet portion 720. At this time, the second inlet portion 730 is formed at the upper side of the second header tank 200 in the longitudinal direction of the second header tank 200, and the second outlet portion 740 is formed at the second space portion 102 of the first header tank 100, so that the second heat exchange medium introduced into the heat exchange member 500 at the interior of the third space portion 201 of the second header tank 200 through the second inlet portion 730 is primarily cooled through the heat exchange with the first heat exchange medium, moved to the fourth space portion 202 of the second header tank 200 and to the second space portion 102 of the first header tank 100 along the second tubes 400, secondarily cooled with the heat exchange with the external air, and discharged through the second outlet portion 740.

The configuration of the integral heat exchanger 1000 as shown in FIG. 6 is similar to that as shown in FIG. 3, wherein the first space portion 101 of the first header tank 100 is partitioned in the longitudinal direction of the first header tank 100, and the first outlet portion 720 is formed at the lower side of the first space portion 101.

The configuration of the integral heat exchanger 1000 as shown in FIG. 7 is similar to that as shown in FIG. 6, wherein the fourth space portion 202 of the second header tank 200 is partitioned in the longitudinal direction of the second header tank 200, and the second outlet portion 740 is formed at the lower side of the fourth space portion 202.

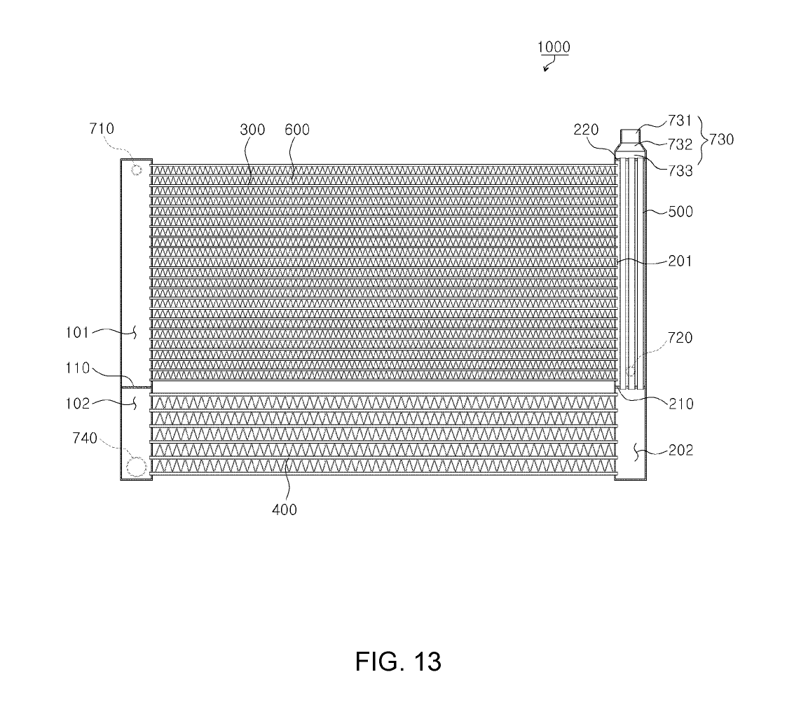

At this time, the integral heat exchanger 1000 according to the present invention further includes a third partition member 220 for partitioning one side of the second header tank 200 and the second inlet portion 730, as shown in FIGS. 12 and 13. The third partition member 220 has a shape of a plate and forms the space in which the second heat exchange medium of the second header tank 200 moves. The third partition member 220 has insertion holes 221 hollowed thereon in such a manner as to correspond to the plurality of pipes of the heat exchange member 500, thus allowing the second heat exchange medium to be introduced into the heat exchange member 500 through the second inlet portion 730.

The second outlet portion 740 is formed on the second space portion 102 of the first header tank 100 and discharges the second heat exchange medium.

Accordingly, the integral heat exchanger 1000 according to the present invention is configured wherein the second heat exchange medium introduced through the second inlet portion 730 is passed through the second heat exchange area A2 in which the heat exchange is conducted in the water-cooled way and through the third heat exchange area A3 in which the heat exchange is conducted in the air-cooled way, and discharged through the second outlet portion 740. At this time, the second heat exchange area A2 is the area in which the second heat exchange medium is heat-exchanged with the first heat exchange medium, while passing through the heat exchange member 500, and the third heat exchange area A3 is the area in which the second heat exchange medium is heat-exchanged with the external air, while passing through the fourth space portion 202 of the second header tank 200, the second tubes 400, and the second space portion 102 of the first header tank 100.

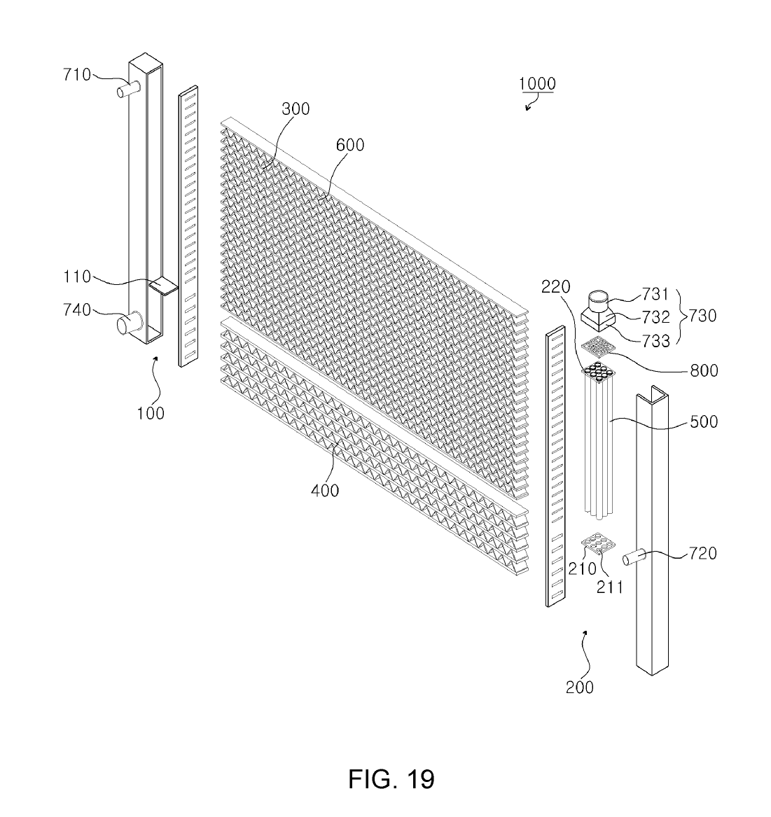

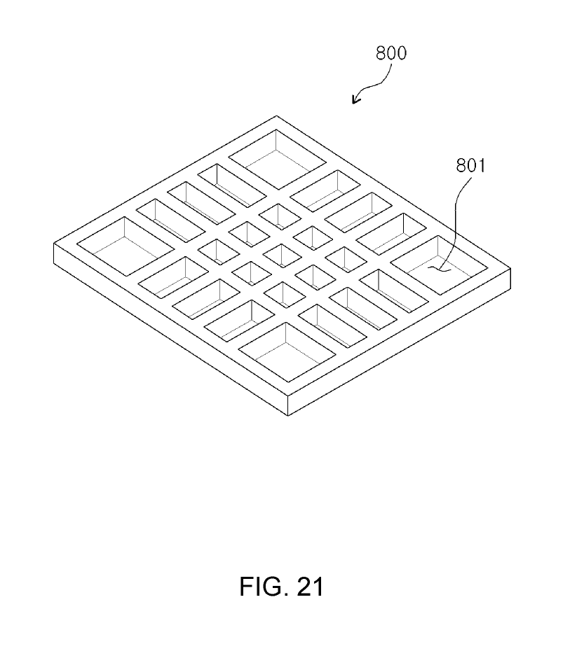

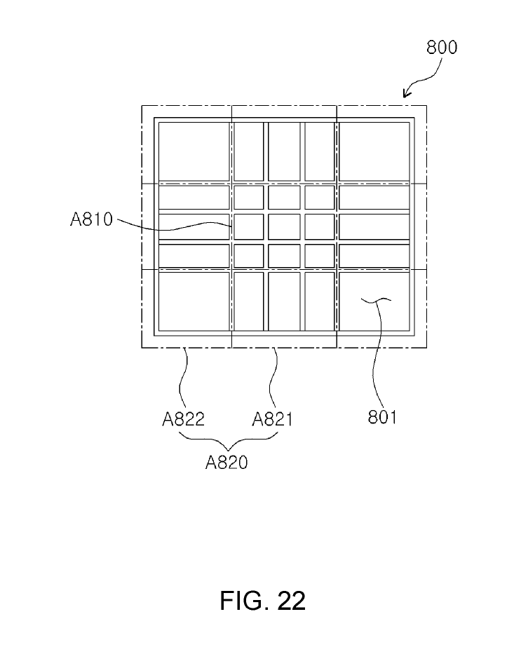

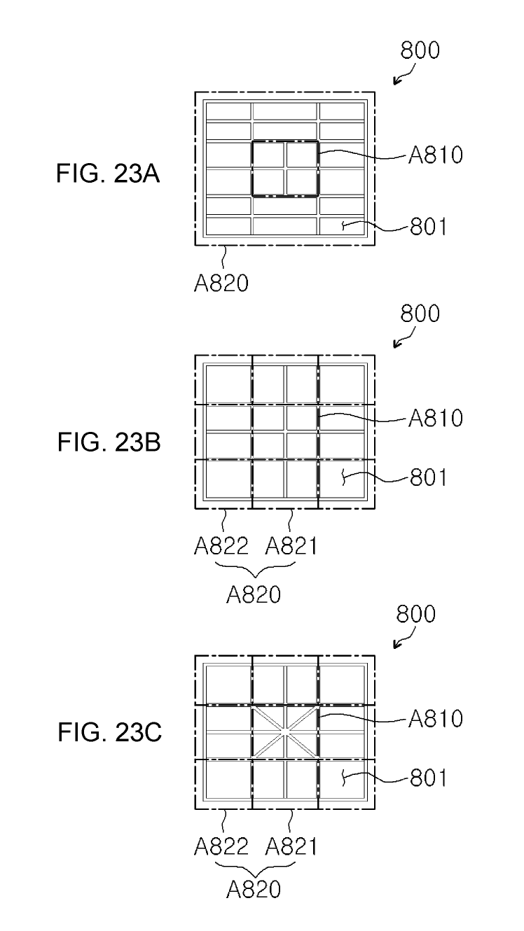

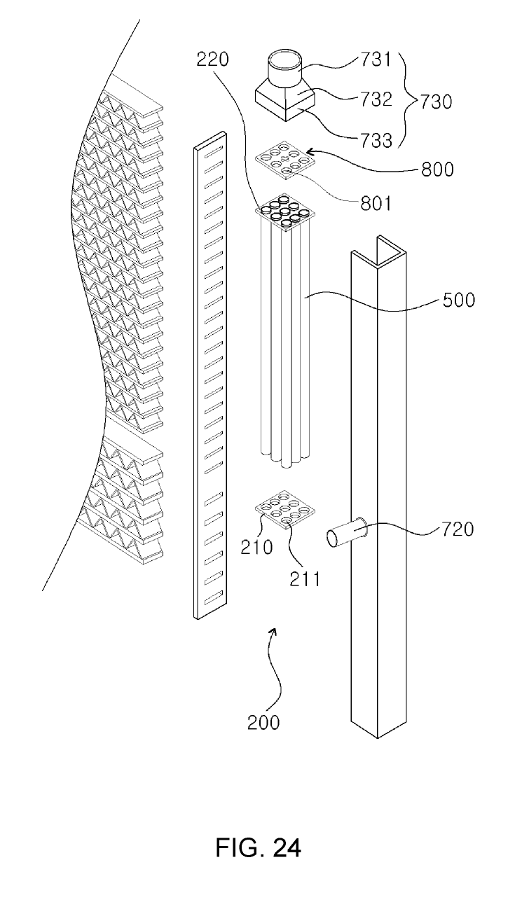

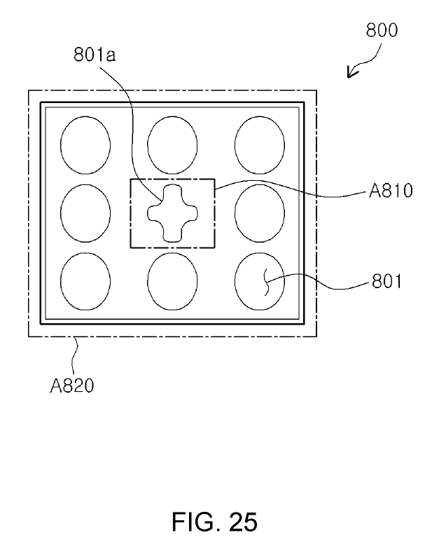

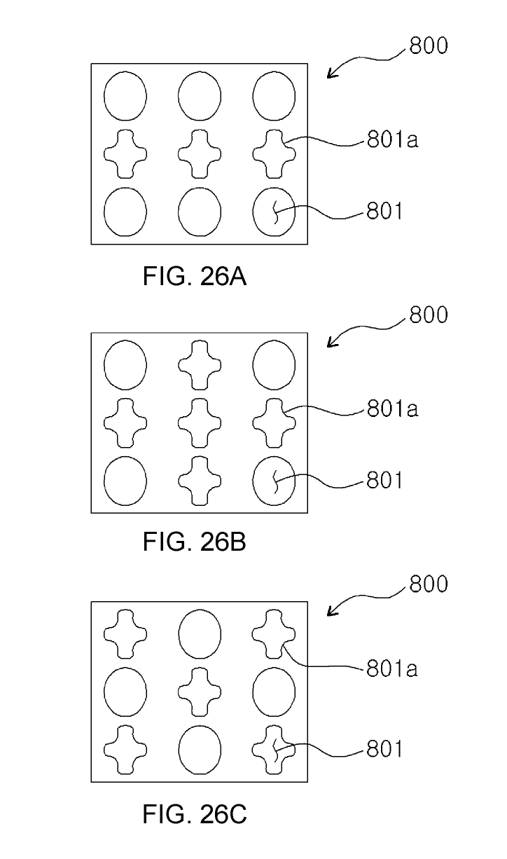

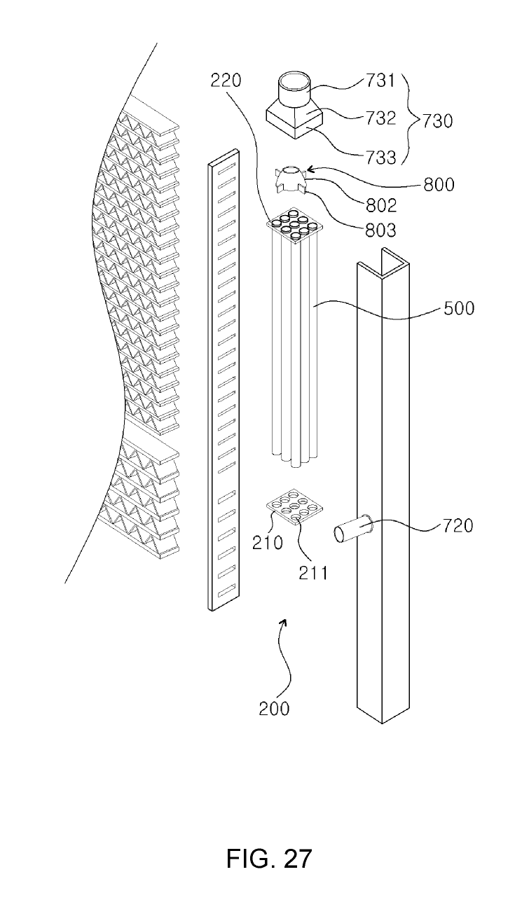

FIGS. 19 to 22 are exploded perspective and sectional views showing an integral heat exchanger according to an eighth embodiment of the present invention and perspective and plan views showing a distribution member in the integral heat exchanger according to the present invention, FIGS. 23a to 23c are plan views showing other distribution members, FIGS. 24 and 25 are an exploded perspective view showing an integral heat exchanger according to a ninth embodiment of the present invention and a plan view showing a distribution member in the integral heat exchanger according to the present invention, FIGS. 26a to 26c are plan views showing other distribution members, and FIGS. 27 to 29 are an exploded perspective and partial sectional views showing an integral heat exchanger according to a tenth embodiment of the present invention and a perspective view showing a distribution member in the integral heat exchanger according to the present invention.

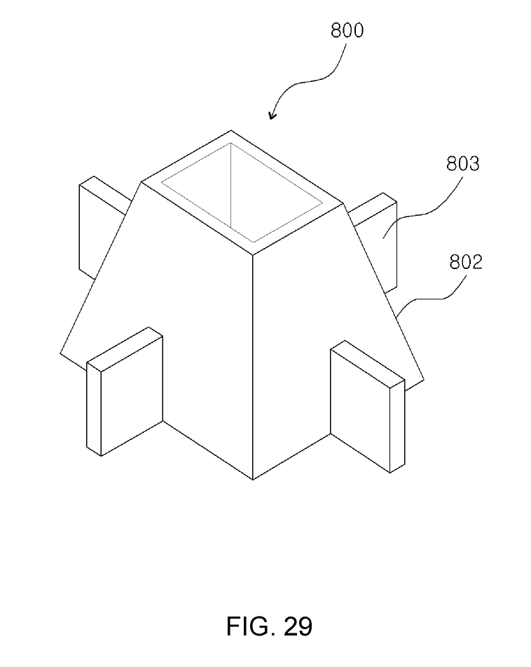

As shown in FIGS. 19 and 29, the integral heat exchanger 1000 according to the present invention further includes a distribution member 800.

The distribution member 800 is located inside the second inlet portion 730 so as to evenly distribute the second heat exchange medium to the heat exchange member 500 from the second inlet portion 730. If the heat exchange member 500 includes the plurality of pipes, the second heat exchange medium may be collected to specific pipes of the heat exchange member 500, and accordingly, the distribution member 800 is provided to solve the above problem.

In more detail, the distribution member 800 as shown in FIGS. 19 to 26c has a shape of a plate having a plurality of communication holes 801 formed thereon, and the distribution member 800 as shown in FIGS. 27 to 29 has an inclined portion 802 and support portions 803. First, the distribution member 800 as shown in FIGS. 19 to 26c has the shape of the plate having the communication holes 801 hollowed thereon, and the hollowed areas of the communication holes 801 in which the second heat exchange medium is collected are smaller than those of other communication holes 801.

At this time, the distribution member 800 includes a first communication area A810 located at the center thereof, to which the second heat exchange medium is collected best, and a second communication area A820 formed around the first communication area A810, in which the hollowed areas of the communication holes 801 are larger than those of the communication holes 801 on the first communication area A810. Further, the second communication area A820 includes third communication areas A821 and fourth communication areas A822. The fourth communication areas are located adjacent to the corners and have the hollowed areas of the communication holes 801 larger than those of the communication holes 801 on the third communication areas A821. That is, the hollowed area of the communication holes 801 formed at the center area in which the second heat exchange medium is collected best is smallest (which is the first communication area A810) among the entire area, and the hollowed areas of the communication holes 801 formed at the corner areas in which the second heat exchange medium is not moved gently are largest (which are the fourth communication areas A822) among the entire area. The communication holes 801 of the distribution means 800 having the first communication area A810 and the second communication area A820 may have various patterns, and in addition to the hollowed areas of the communication holes 801 as shown in FIGS. 19 to 23c, they may be freely varied. Further, the distribution member 800 as shown in FIGS. 24 to 26c has the communication holes 801 formed correspondingly to the respective pipes constituting the heat exchange member 500. As shown in FIG. 25, if the heat exchange member 500 includes nine pipes, the communication holes 801 of the distribution member 800 are nine. For example, since the areas of the communication holes 801 in which the second heat exchange medium is collected should be smaller than those of other communication holes 801, the communication hole 801 formed on the area in which the second heat exchange medium is collected has second concave portions 801a concaved inwardly therefrom. At this time, the second concave portions 801a are concaved inwardly from the outer peripheral surface of the communication hole 801, thus reducing the communication area of the communication hole 801. The distribution member 800 as shown in FIGS. 24 and 25 is configured wherein the communication hole 801 formed at the center thereof has the second concave portions 801a and the others have a circular shape. In this case, the communication hole 801 formed at the center thereof forms the first communication area A810, and the communication holes 801 formed around the center form the second communication area A820. On the other hand, as shown in FIGS. 26a to 26c, the integral heat exchanger 1000 according to the present invention has a variety of arrangements of the communication holes 801 having the second concave portions 801a. As shown in FIG. 26a, the communication holes 801 having the second concave portions 801a are formed at a second row, and as shown in FIG. 26b, the communication holes 801 having the second concave portions 801a are formed at a second row and at a second column. As shown in FIG. 26c, the communication holes 801 having the second concave portions 801a are formed at the center of the distribution member 800 and at the four corners thereof.

The distribution member 800 as shown in FIGS. 27 to 29 has the inclined portion 802 and the support portions 803, and the inclined portion 802 is increased in width as it goes from the second inlet portion 730 to the interior of the second header tank 200, thus allowing the second heat exchange medium collected at the center of the distribution member 800 to be distributed to the periphery thereof.

The support portions 803 support the inclined portion 802 so that the inclined portion 802 is fixed to the second inlet portion 730.

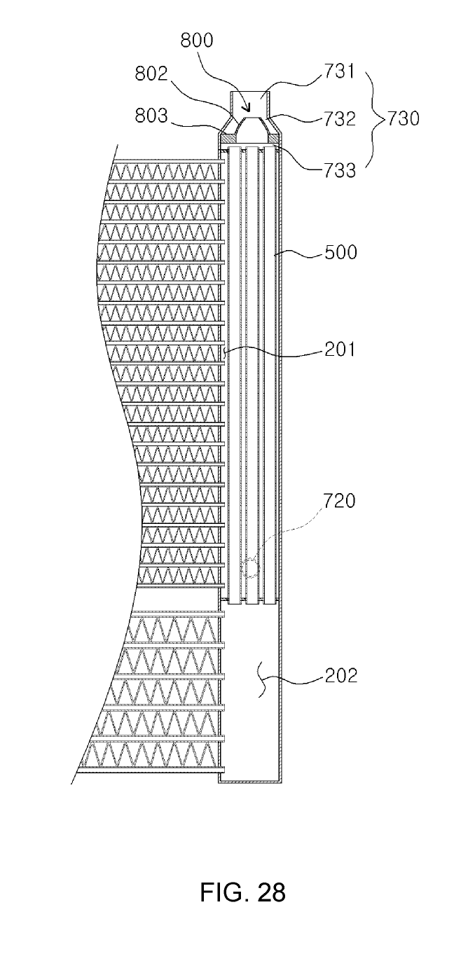

At this time, the inclined portion 802 as shown in FIGS. 27 and 28 has a circular section, and that as shown in FIG. 29 has a square section. According to the present invention, the distribution member 800 may have various polygonal sections only if the communication area is increased as it goes from the second inlet portion 730 to the interior of the second header tank 200.

Therefore, the integral heat exchanger 1000 according to the present invention further includes the distribution member 800 located on the second inlet portion 730 so that the second heat exchange medium can be evenly supplied to the heat exchange member 500 having the plurality of pipes, thus advantageously enhancing the heat exchange efficiencies.

At this time, the second inlet portion 730 includes the pipe-shaped connection portion 731 formed in the longitudinal direction of the second header tank 200, the expanded portion 732 extended from the connection portion 731 in such a manner as to be increased in an internal diameter, and the fixed portion 733 extended from the expanded portion 732 in such a manner as to be fixed to one side of the second header tank 200. Accordingly, the integral heat exchanger 1000 according to the present invention is easily connected to a pipe for supplying the second heat exchange medium thereto, thus minimizing the loss in the pressure of the second heat exchange medium. In this case, the distribution member 800 is desirably disposed at the fixed portion 733 of the second inlet portion 730.

According to the integral heat exchanger 1000 of the present invention, particularly, the first heat exchange medium is cooling water for electronic parts, and the second heat exchange medium is charge air. According to the present invention, the electronic parts include a motor, an inverter, and a battery stack as well as an engine, and in addition thereto, they include the parts that have a heating temperature lower than the engine and needed to be cooled. That is, the integral heat exchanger 1000 according to the present invention advantageously provides the heat exchanger for the electronic parts and the intercoolers.

As described above, the integral heat exchanger according to the present invention includes the first heat exchange portion for performing the heat exchange of the first heat exchange medium with external air, the second heat exchange portion formed in the first header tank of the first heat exchange portion or the second header tank to perform the heat exchange of the second heat exchange medium with the first heat exchange medium, and the third heat exchange portion for introducing the second heat exchange medium passing through the second heat exchange portion and performing the heat exchange of the second heat exchange medium with external air, wherein the first to third heat exchange portions are formed in one body integrally to each other.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An integral heat exchanger comprising:
a first header tank and a second header tank disposed in parallel and spaced apart from each other by a distance;
a first partition member disposed transverse to a longitudinal direction of the first header tank, the first partition member partitioning an inner space of the first header tank into a first space portion and a second space portion;
a second partition member disposed transverse to a longitudinal direction of the second header tank, the second partition member partitioning an inner space of the second header tank into a third space portion and a fourth space portion;
a plurality of first tubes connecting the first space portion of the first header tank and the third space portion of the second header tank to form a plurality of first heat exchange medium passages;
a heat exchange member disposed in the third space portion of the second header tank in the longitudinal direction of the second header tank to form a space through which a second heat exchange medium flows to the fourth space portion;
a plurality of second tubes connecting the second space portion of the first header tank and the fourth space portion of the second header tank to form a plurality of second heat exchange medium passages; and
a plurality of fins disposed between each of the first tubes and between each of the second tubes.

2. The integral heat exchanger according to claim 1, further comprising:
a first inlet portion formed on one of the first space portion of the first header tank and the third space portion of the second header tank to introduce a first heat exchange medium to the integral heat exchanger;
a first outlet portion formed on one of the first space portion of the first header tank and the third space portion of the second header tank to discharge the first heat exchange medium from the integral heat exchanger;
a second inlet portion formed on the third space portion of the second header tank to introduce the second heat exchange medium to the heat exchange member; and
a second outlet portion formed on the second space portion of the first header tank to discharge the second heat exchange medium from the integral heat exchanger.

3. The integral heat exchanger according to claim 2, wherein the heat exchange member has a shape of a longitudinally elongated pipe.

4. The integral heat exchanger according to claim 3, wherein the heat exchange member includes at least two pipes.

5. The integral heat exchanger according to claim 4, wherein the heat exchange member further comprises a plurality of first pipes having a first sectional shape and a plurality of second pipes having a second sectional shape.

6. The integral heat exchanger according to claim 5, wherein an internal cross-sectional area of each of the second pipes is smaller than an internal cross-sectional area of each of the first pipes.

7. The integral heat exchanger according to claim 6, wherein each of the second pipes has a first concave portion formed inwardly with respect to a peripheral surface of the second pipes, the first concave portion extending along a longitudinal direction of each of the second pipes.

8. The integral heat exchanger according to claim 3, wherein the heat exchange member has a spiral protrusion formed along a peripheral surface of the heat exchange member.

9. The integral heat exchanger according to claim 2, wherein the heat exchange member is a plate, the heat exchange member partitioning an internal space of the second header tank into two sides in the longitudinal direction of the second header tank.

10. The integral heat exchanger according to claim 2, further comprising a third partition member partitioning one side of the second header tank and the second inlet portion.
